(19) United States
(12) Patent Application Publication
(10) Pub. No.: US 2011/0243822 A1
(43) Pub. Date: Oct. 6, 2011

(54) FLUE GAS CLEAN UP METHODS

(75) Inventor: MURRAY EDWARD ARNE MORTSON, Chestermore (CA)

(73) Assignee: AIRBORNE TECHNOLOGIES INC., Calgary (CA)

(21) Appl. No.: 12/751,790

(22) Filed: Mar. 31, 2010

(51) Int. Cl. B01D 53/62; C01B 21/093; C01B 21/20

(52) U.S. Cl. 423/232; 423/388; 423/387

(57) ABSTRACT

The present invention relates to a method for potassium or nitrogen based fertilizer production from the byproducts of flue gas processing. Further, the present invention relates to a method for isolating fertilizer precursors from a stream of flue gas. The method including a dry sorbent operation, wet scrubbing operation and an oxidization step to remove air pollutants, a carbon dioxide capture step and a sodium bicarbonate precipitation step. The steps involved in the removal of air pollutants are used to isolate precursors for the production of fertilizer. Additionally, the present invention relates to a method for the removal of carbon dioxide from a flue gas stream.

### FIELD

The present invention relates to a method for potassium or nitrogen based fertilizer production from the byproducts of flue gas processing.

### BACKGROUND

Methods for cleaning flue gas are of interest. While many processes have been suggested, many create very harmful byproducts or require costly inputs.

### SUMMARY

In accordance with a broad aspect of the present invention there is provided a method for the isolation of fertilizer salt precursors from a flue gas stream containing SOx, HCl, HF and NOx compounds, said process comprising the steps of: providing the flue gas stream; processing the flue gas to form a feedstock, said processing comprising: a dry injection scrubbing operation; a wet scrubbing operation; and a carbon dioxide capture operation; converting the feedstock, through a conversion step to form a sodium bicarbonate precipitate, said conversion step comprising: adding combined salt containing ammonium bicarbonate and Glauber's salt to the feedstock; adding to the feedstock at least one of: carbon dioxide and ammonia gas; or ammonium bicarbonate; maintaining an ammonium to sodium ratio of not less than 1; removing said sodium bicarbonate precipitate out of solution from step (iii); mixing said solution from step (c)(iv) with a double salt (make number of dependant claims for the double salt) what do you want here in brackets or why is this text here; cooling said mixture from step (d) to form a combined salt; precipitating the combined salt and removing the combined salt out of solution from step (e); removing residual bicarbonate from the solution from step (f); mixing said solution from step (f) with a mother liquor prepared from steps (a) to (g) and further cooled to precipitate out and remove there from a double salt and from which an ammonium salt (dependant claims for sulfate and nitrate) what do you want to do here in brackets has been concentrated and removed; cooling the mixture from step (h) to precipitate double salt; separating precipitated double salt the solution from step (i) and recycling to step C; and recovering ammonium salts by concentrating the solution of step (j).

In accordance with another broad aspect of the present invention there is provided a method for removing carbon dioxide from a feed stock, comprising: processing a flue gas stream to remove substantially all SOx, HCl, HF, mercury and NOx contaminants; cooling the flue gas stream to a temperature in the range of 100 to 175 degrees F.; exposing the flue gas to a substantially pure sodium carbonate in a environment with water present to remove carbon dioxide from said flue gas stream to create carbonated sodium carbonate; heating said created carbonated sodium carbonate to a temperature in the range of 200 to 350 degrees F. to release carbon dioxide and water producing substantially pure sodium carbonate; and recycling said substantially pure sodium carbonate back to step (a) to remove carbon dioxide from the flue gas stream.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### DESCRIPTION OF DRAWINGS

Referring to the drawings, several aspects of the present invention are illustrated by way of example, and not by way of limitation, in detail in the Figure s, wherein:

FIG. 1 is a schematic flow diagram of the present invention.

FIG. 2 is a schematic flow diagram of one embodiment of the present invention.

FIG. 2A is a schematic flow diagram of one embodiment of the present invention.

FIG. 3 is a schematic flow diagram of one embodiment of the present invention.

FIG. 3A is a schematic flow diagram of one embodiment of the present invention.

FIG. 4 is a schematic flow diagram of one embodiment of the present invention.

FIGS. 5 and 6 are Janecke diagrams of the chemical equilibrium involved in a sodium bicarbonate precipitation step in one embodiment of the present invention.

FIG. 7 is a Janecke diagram of the chemical equilibrium involved in a combined salt precipitation step in one embodiment of the present invention.

FIG. 8 is temperature-composition phase diagram that represents the chemical equilibrium involved in the production of ammonium sulfate from a solution of ammonium, sulfate and sodium ions.

FIG. 9 is a schematic flow diagram of a wet scrubber process of one embodiment of the present invention.

### DETAILED DESCRIPTION

The detailed description set forth below in connection with the appended drawings is intended as a description of the present invention and is not intended to represent the only embodiments contemplated by the inventor. The detailed description includes specific details for the purposes of providing a comprehensive understanding of the present invention. However, it will be apparent to those skilled in the art that the present invention may be practiced without these specific details.

The present invention is a method for the manufacture of fertilizer that utilizes a feedstock comprised of by-products from the processing of flue gas. Said feedstock, at least, provides sodium sulfate, carbon dioxide and sodium nitrate reactants for various chemical reactions in the process of manufacture. The feedstock may also contain other compounds such as sodium sulfite, sodium carbonate, sodium chloride, sodium fluoride, and sodium nitrite. The feedstock may be pretreated to increase purity of the reactants sodium sulfate and sodium nitrate. A crystallization process may be employed to extract sodium bicarbonate from the feedstock and the sodium bicarbonate may be utilized in various upstream, pretreatment processes. The resulting fertilizer may contain ammonium sulfate and ammonium nitrate.

Flue gas may be processed to remove the by-products of fossil fuel combustion, such as air pollutants and toxins including but not limited to Mercury. The processing may produce by-products that may comprise a viable feed stock for fertilizer production, for example sodium sulfate and sodium nitrate.

### Fertilizer Manufacture

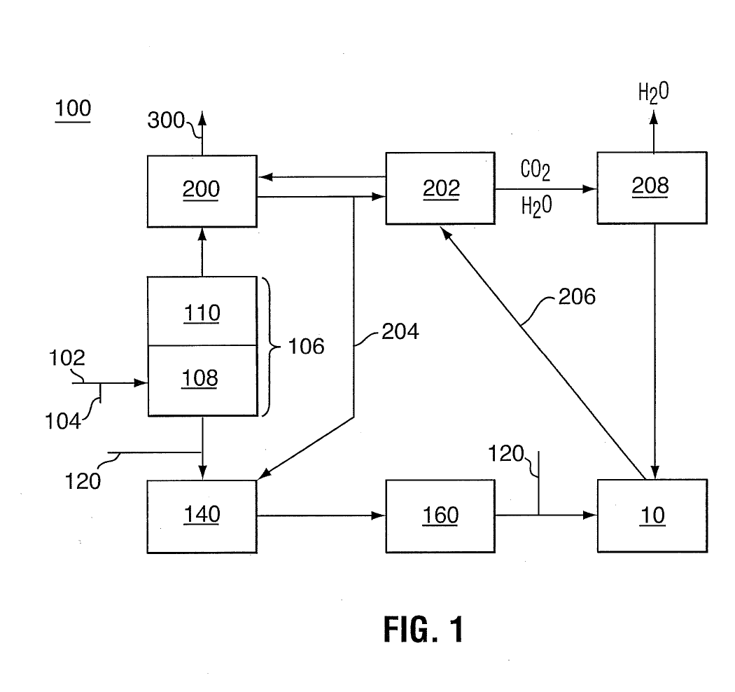

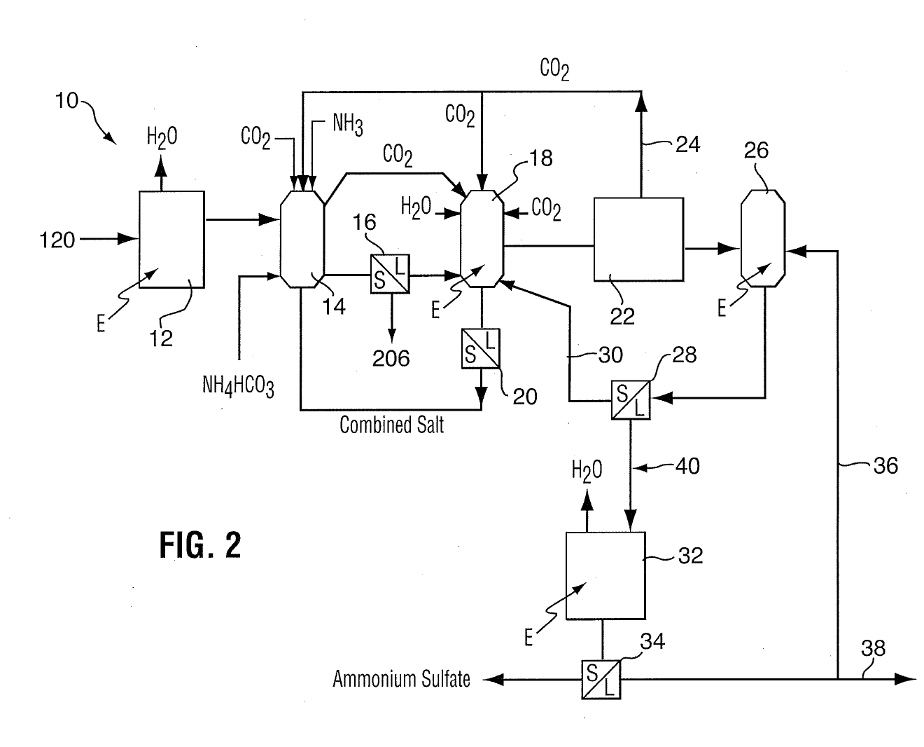

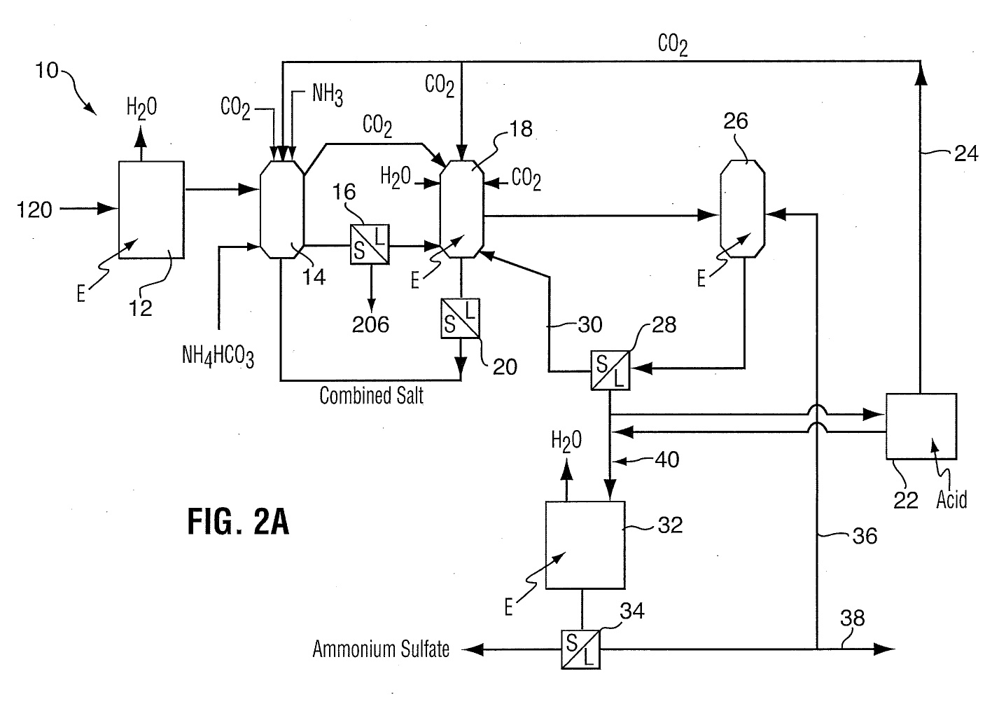

In FIG. 1, the overall process for manufacturing fertilizer in accordance with a first embodiment is illustrated and globally referenced as numeral 10. As will be discussed further below, the feedstock 120 may be pretreated by a process, generally denoted as 100 to remove by-products of the flue gas production. Further, following process 100 the feedstock may be further processed to increase the solute concentration so that the feedstock becomes saturated or nearly saturated in order to maximize the once-through conversion of the sodium sulfate, sodium nitrate and ammonium bicarbonate or carbon dioxide and ammonia feeds to a crystallizer. In the flow diagram shown of FIG. 2, for example, a simple evaporation 12 drives off moisture and thus increases the concentration of sodium sulfate and sodium nitrate in the solution feedstock. Any suitable means may be used to achieve this function.

This detail is important in minimization of the size of the recycle streams required to achieve 100% conversion of the feedstock to sodium bicarbonate and reactants for fertilizer production. Minimization of recycle stream size relates to the optimal ammonium to sodium ratio in the crystallizer and this can increase the once through conversion of the reactants to sodium bicarbonate from as low as 30% to as high as 65%. By maximizing the once through conversion, the energy consumption of the process can be reduced by a factor of 10.

It has been found that the optimal ammonium to sodium feed ratio to the sodium bicarbonate precipitation step is that which results in a slight excess of ammonium (ratio of between 1.01 and 1.10). Although on a once through basis, an ammonium to sodium ratio of 0.912 results in the greatest once through conversion to sodium bicarbonate, the large recycle stream sizes that result from the excess sodium rapidly deteriorate process economic viability.

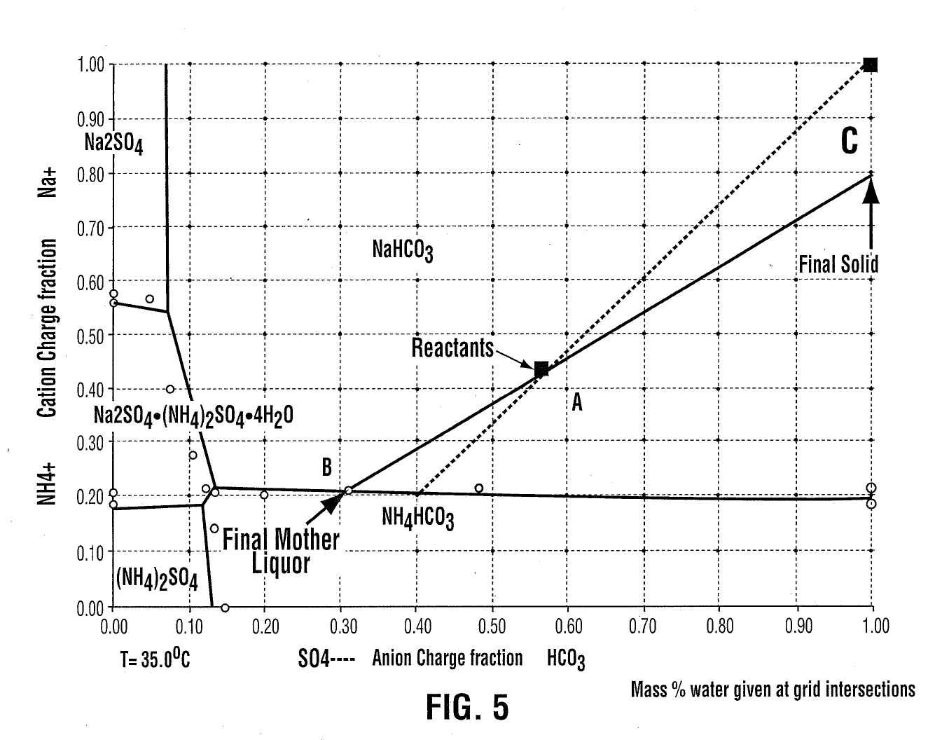

The preparation of the sodium sulfate and sodium nitrate will occur in vessel 12 and once prepared, the solution is then transferred to a precipitator 14 for precipitating sodium bicarbonate. This precipitation is accomplished by the addition of carbon dioxide gas and ammonia liquid or gas or ammonium bicarbonate in solution together with combined salt (ammonium bicarbonate and Glauber's salt derived from a further unit operation discussed further below) in the correct combination to achieve the previously discussed optimal ammonium to sodium ratio. In the further combined salt precipitation step 18, double salt contamination (containing ammonium sulfate product) in the combined salt precipitate will reduce the overall process efficiency by reducing the once through efficiency of the sodium bicarbonate crystallizer. As one can appreciate combined salt precipitation step 18 may take place in precipitator 14, or in a separate vessel. To one skilled in the art, the inclusion of double salt in the combined salt will pull the reactant point on the Janecke (see FIG. 5 and Example 1) towards the sodium bicarbonate/ammonium bicarbonate solubility line which by the use of the lever rule will reduce the once through process efficiency. In addition, it has been found optimal to maintain the temperature of the combined slurry in vessel 14 in the optimal range for sodium bicarbonate precipitation of 95 to 104 degree F.

The chemical equilibrium involved in the sodium bicarbonate precipitation step may be used to maximize the once through conversion to sodium bicarbonate in vessel 14. The ability to maximize the once through conversion in the sodium bicarbonate precipitator allows one skilled in the art to optimize the economics of the invention and ensure economic viability. The sodium bicarbonate precipitate and solution are then separated in a separator 16, for example a centrifuge, where the solid is separated and dried in a dryer to comprise a high purity sodium bicarbonate source. As will be discussed further hereinafter, the high purity sodium bicarbonate source may be employed in upstream, pretreatment processes.

The liquid from separator 16 is then mixed with an ammonium sulfate/sodium sulfate double salt derived from a further unit operation and possibly some water and cooled (optimally between 28.4 and 35.6 degree F.) in vessel 18 resulting in the precipitation of an ammonium bicarbonate/Glauber's salt combined salt. The temperature range of 28.4 and 35.6 degree F. is optimal but it should be apparent to one skilled in the art that a wider temperature range will work, although not as efficiently. The combined salt is separated from the solution in separator 20. The combined salt is then reintroduced into the sodium bicarbonate precipitation stage in vessel 14 as the ions in the combined salt represent unused reactants and not products (ammonium sulfate). The water and bicarbonate concentration in the combined salt precipitation step are extremely important. If the water and bicarbonate concentration are not correct, the sodium sulfate/ammonium sulfate double salt could also precipitate and contaminate the combined salt. As such, the correct amount of water and bicarbonate in the form of carbon dioxide have to be added to this step to ensure the precipitation of combined salt only. Possible sources of carbon dioxide to be added to vessel 18 include the carbon dioxide produced in the sodium bicarbonate precipitation step, the carbon dioxide derived from the further bicarbonate removal step or an external carbon dioxide source.

The precipitation and recycling of the combined salt is essential to obtaining nearly 100% conversion of the sodium salt feed to sodium bicarbonate in an economical manner. Without the combined salt precipitation step, all of the unconverted bicarbonate from vessel 14 would feed ahead to an acidification step 22 and would have to be recovered and recycled as gaseous carbon dioxide. One skilled in the art will readily recognize that it is far less energy intensive to recycle the unconverted bicarbonate as a solid rather than a gas. In addition, if double salt containing ammonium sulfate or ammonium nitrate (process products) contaminates the combined salt precipitate, then ammonium sulfate is unnecessarily recycled back to the beginning of the process resulting in further deterioration of the viability of the process through increased energy consumption due to reduced once through conversion.

The solution from vessel 18 is then treated by an acidification operation, broadly denoted by numeral 22 to remove residual bicarbonate from the solution. Removal of the residual bicarbonate is essential to the production of pure ammonium sulfate and ammonium nitrate fertilizer in a further unit operation. The acidification may comprise any suitable acid treatment such as sulfuric acid. Once the sulfuric acid contacts the solution, the carbonates are liberated from the solution as carbon dioxide because of the pH dependent equilibrium between bicarbonate ion and aqueous carbon dioxide. The carbon dioxide is then returned to vessel 14 or 18 via line 24. The solution is then mixed with mother liquor derived from the downstream ammonium sulfate concentration step 32, passed to vessel 26 and cooled (optimally between 28.4 and 35.6 degree F.) to precipitate double salt. The subsequent solution and double salt solid are separated by separator 28. The temperature range of 28.4 and 35.6 degree F is optimal but it should be apparent to one skilled in the art that a wider temperature range will work, although not as efficiently.

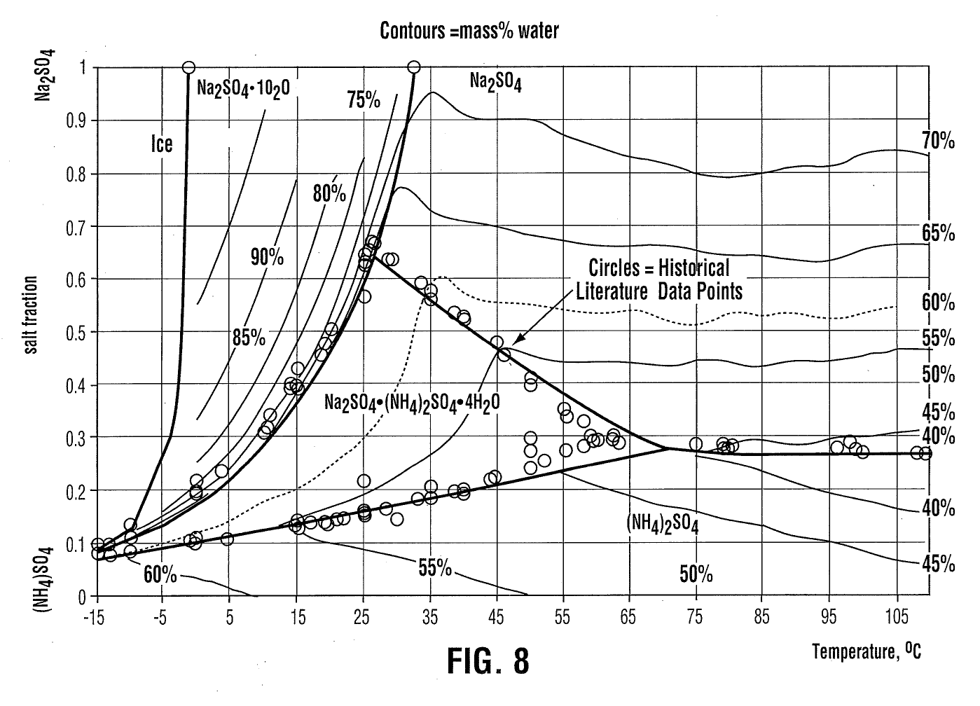

The double salt is returned via line 30 to the combined salt precipitator vessel 18. The precipitation of double salt in this step is essential to the ability of the invention to produce high quality ammonium sulfate fertilizer product. If the amount of sodium in the solution feeding the ammonium sulfate precipitation step 32 is not controlled (by precipitating and recycling the double salt), it is not possible to precipitate high quality ammonium sulfate. Example 4, to follow, will illustrate the importance of understanding how the sodium content of the solution feeding the ammonium sulfate precipitation step has to be controlled to produce high quality ammonium sulfate. FIG. 8 illustrates the chemical equilibrium involved.

The solution from separator 28 is exposed to a concentration operation, globally denoted by 32, where the ammonium sulfate bearing solution is concentrated to cause ammonium sulfate precipitation. This could be achieved by any known means such as straight forward evaporation. The solution is then separated from the solid by separator 34. The solid comprises high quality ammonium sulfate or ammonium nitrate fertilizer wet cake which can then be washed and formulated into a marketable form. The solution is returned to the double salt precipitator via line 36. As one can appreciate, the quantity of ammonium sulfate and ammonium nitrate can depend on the sodium nitrate feedstock that is extracted from the flue gas.

In the event that the feedstock of sodium sulfate and sodium nitrate was not derived from a pure sodium sulfate/sodium nitrate source, for example, from a flue gas purification process utilizing dry and/or wet sodium bicarbonate scrubbing, the feedstock may contain impurities such as but not limited to sodium chloride, sodium fluoride, etc. If these impurities are present they may be purged from the system at 38. This purge does not degrade the economics of the process as the purge itself may be a valuable nitrogen product if it contains other ammonium salts in solution. The impurities (Cl, F, Na, etc.) will be in low enough concentrations when the inlet sodium sulfate/sodium nitrate solution is derived from, for example, a flue gas source to allow the stream to be sold as a liquid nitrogen fertilizer product.

As can be appreciated, the presence of impurities can depend upon the source of the feedstock. For example, if the feedstock is derived from the by-products of processed flue gas, it will be appreciated that the constituents of the fossil fuel that produces the flue gas will determine the nature and amounts of impurities within the feedstock. In one embodiment of the present invention, the feed stock may be subject to a pre-treatment step 100. The nature of the pre-treatment step can depend upon the constituents of the feedstock. For example, the pre-treatment step may require, for example, a pH adjustment to remove undesirable metals and constituents by the addition of a basic agent, such as sodium hydroxide or sodium carbonate. Such a pH adjustment may cause heavy metal constituents of the feedstock to form removable complexes so that the fertilizer end-product is not contaminated with said heavy metals. As will be discussed further below, a decarbonation vessel 202, which is a step in process 100, may provide a source of sodium carbonate 204 for said pH adjustments of the feedstock.

Following optional pre-treatment step 140, the feed stock may also be subject to a filter step 160. For example, as described above, pH adjustments may cause coagulation of heavy metal complexes, which can be physically filtered from the feedstock using techniques known to those skilled in the art. For example, filters may comprise particle filters that have pores to prevent large particles, such as fly ash and dirt from forming part of the feedstock. Filters may also comprise activated carbon filters to remove organic contaminants from the feed stock. Further, filters may comprise resin-type filters to remove any charged contaminants. The filter step may comprise one or more of the aforementioned filter types to remove heavy metals, organic contaminants and other minerals, as the operator determines is appropriate based upon the constituents of the feedstock source.

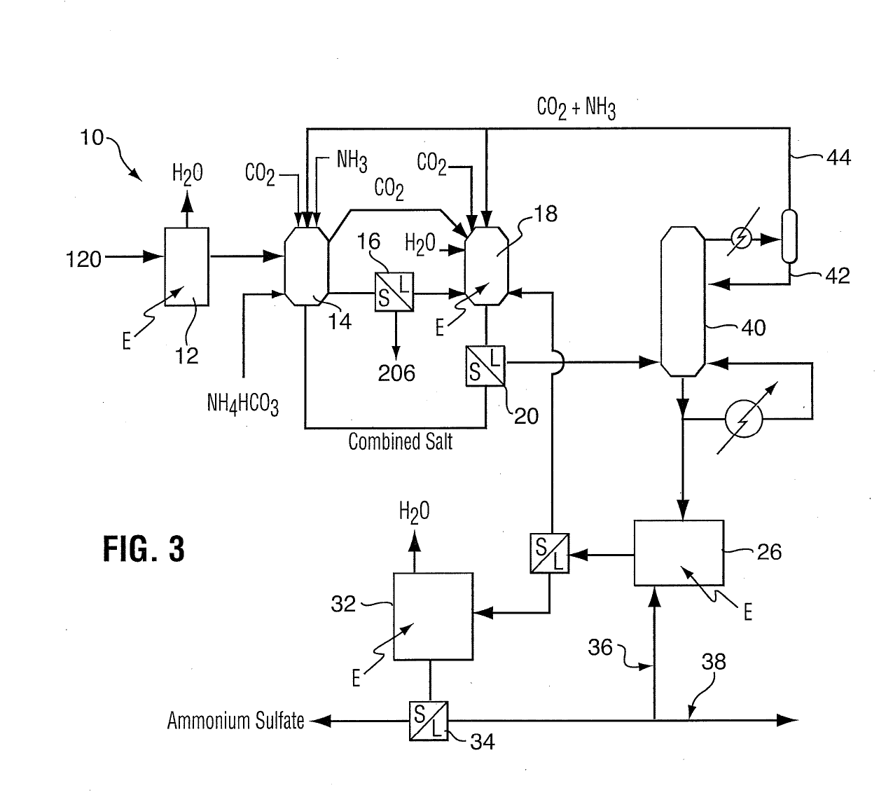

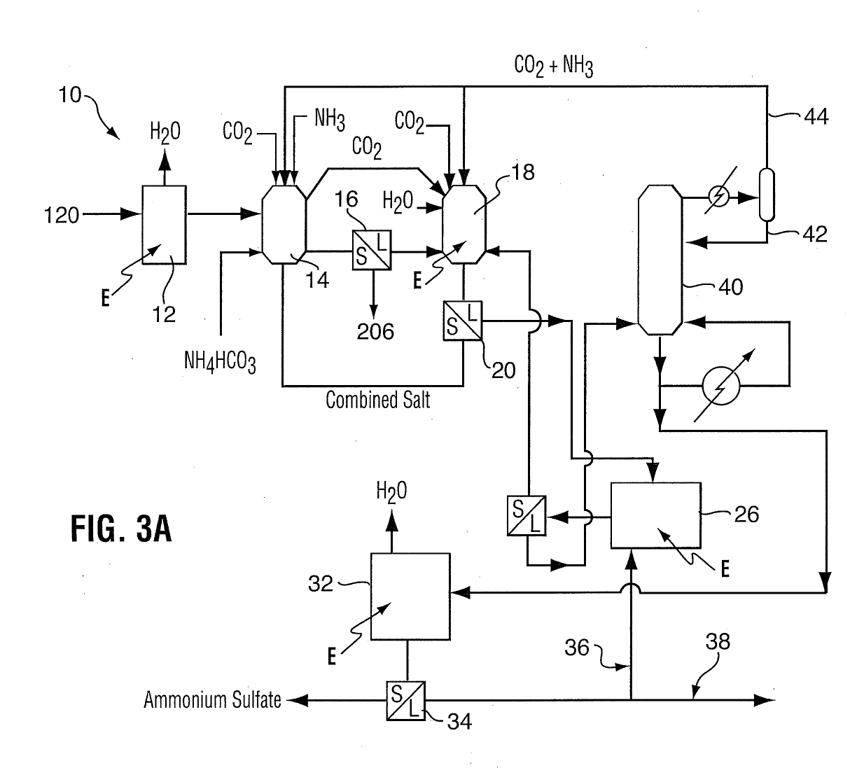

As an alternative, FIG. 3 illustrates a different embodiment with respect to the preparation of the sodium bicarbonate and ammonium sulfate/ammonium nitrate.

The solution from separator 20 is passed into a bicarbonate stripping tower 40 which may be of the packed or tray type. The tower can be either a refluxed or non refluxed distillation tower. The carbon dioxide and ammonia gases (and water vapor) liberated from solution are recycled via line 44 to vessel 14 or vessel 18. As in the acidification option, the bottoms liquid from the stripper 40 is treated in vessel 26 in order to precipitate the double salt. The rest of the circuit follows the same series of unit operations as those that have been set forth in the discussion for FIG. 1.

In terms of temperature, the overheads from the stripping tower should be kept as low as possible although the process will work over a large temperature range. As low a temperature as possible is ideal because the lower the temperature, the less water carry over there is with the carbon dioxide and ammonia gas. As one skilled in the art will recognize, the minimization of water recycle in the process will minimize energy consumption and equipment size. The practical limit to the minimization of the stripper overhead temperature and water carry over is the fact that if the temperature drops too far below 149 degree F., solid ammonium bicarbonate or other ammonium/carbonate salts will precipitate in the line.

In terms of further alternatives, the bicarbonate removal step (stripper or acid addition) could be located downstream of the double salt crystallization step (vessel 26 (see FIGS. 2A and 3A). Where practical, this configuration would allow for reduced energy consumption.

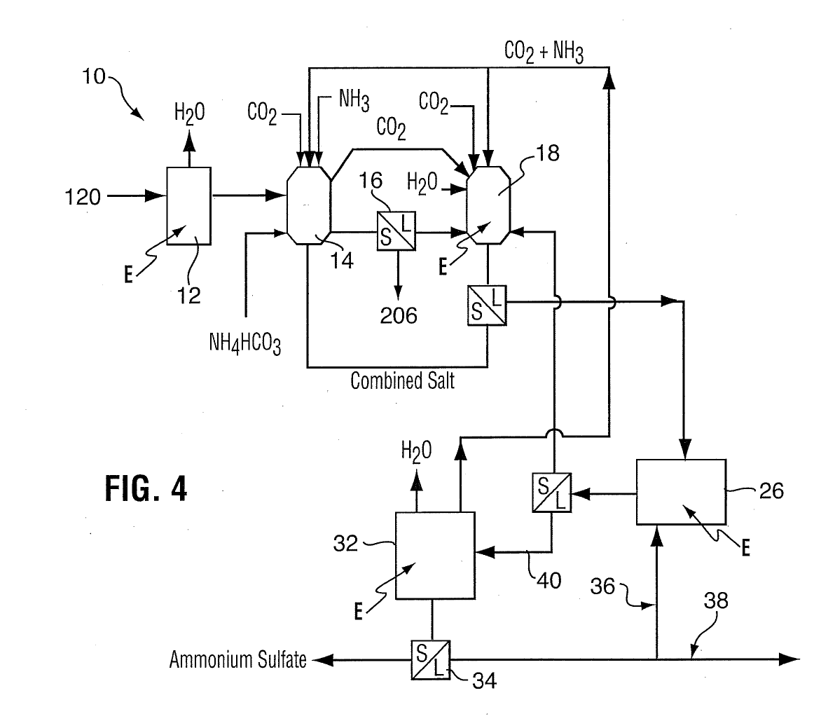

An additional and further alternative would be to carry out the bicarbonate removal step simultaneously with the ammonium sulfate solution concentration step 32. This would eliminate the need for a separate acidification or stripping unit operation for the removal of bicarb (see FIG. 4).

In respect of temperatures, the combined salt and double salt precipitators have been indicated to optimally function in a range of 28.4 to 35.6 degree. F. The sodium bicarbonate precipitation step has been indicated to optimally function in the range of 95 to 104 degree F. To one skilled in the art, it should be apparent that the present invention will work outside of these temperature ranges but at reduced efficiency.

With respect to the individual precipitators and equipment choice, this will depend upon the size of the circuit, desired output, daily quantity, among a host of other factors.

### EXAMPLES

### Example 1

### Determination of Optimal Ammonium to Sodium Ratio in the Sodium Bicarbonate Precipitation Step

The following example illustrates how the complex phase equilibrium chemistry involved in the present invention can be used to determine the optimum ammonium to sodium ratio in the sodium bicarbonate precipitation step. The understanding of the chemistry demonstrated by this example is required for all unit operations within the process.

The following equilibrium reaction equations represent the process in the sodium bicarbonate precipitation step (using either solid ammonium bicarbonate or carbon dioxide and ammonia gas):

Na₂SO₄+2NH₄HCO₃ [symbol] 2NaHCO₃+(NH₄)₂SO₄

Na₂SO₄+2NH₃+2CO₂+2H2O [symbol] 2NaHCO₃+(NH₄)₂SO₄

In order to understand the complexity of the phase equilibrium behavior described in this reaction, a graphical representation of the system is required. The reciprocal salt pair quaternary system described in this reaction can be represented on an isothermal ‘space model’. However, these space models are difficult to use from an engineering perspective and do not easily provide a way of understanding the system as a complete process.

One simplification of the ‘space model’ is known as a Janecke diagram or projection. In a Janecke diagram, the salt and water curves of the ‘space model’ are projected onto a two dimensional graph. The Janecke diagram shown in FIG. 5 represents the phase equilibrium in the sodium bicarbonate crystallizer at a temperature of 95 degree F. (35 degree C.). The abscissa (X axis) is the charge fraction of bicarbonate ions (and aqueous carbon dioxide, carbonate ions (CO₃²⁻) and carbamate ions (NH₂COO⁻)) calculated as follows:

X=Mols HCO₃⁻/(Mols HCO₃⁻+(2XMols SO₄²⁻))

The ordinate (Y axis) is the charge fraction of sodium ions calculated as:

Y=Mols Na⁺/(Mols Na⁺+Mols NH4⁺*)

(*includes aqueous ammonia and carbamate ions)

The saturated water content in weight percent can be shown at the grid intersections. However, for clarity this feature is not included in this figure.

The enclosed areas on the graph represent precipitation areas of the salt indicated with the pure component composition represented at each corner. In these areas, the solution is in equilibrium with the solid salt indicated if the water concentration is low enough to result in precipitation of the salt. The curves or mutual solubility lines on the graph represent solutions in equilibrium with the two salts on either side of the line. The intersection of two lines or curves represents solutions in equilibrium with three salts and is known as an invariant point.

The Janecke diagram in FIG. 5 was created using a UNIQUAC (Universal Quasi Chemical) computer model.

The small circles on the diagram represent measured data points from various published sources lending credibility to the computer model used to generate the diagram.

A crystallizer feed (reactants) contains the following moles of the various ions and 760 g of water:

Na⁺ions=4.219 mols (97.0 g-MW=23 g/mol)
NH₄⁺ions=5.512 mols (99.2 g-MW=18 g/mol)
HCO₃⁻ ions=5.590 mols (341.0 g-MW=61 g/mol)
SO₄₋²⁻ ions=2.115 mols (203.0 g-MW=96 g/mol)

### Total Ions=740.2 g

### Water=760.0 g

### Total Feed (Reactants)=1500.2 g

The cation charge fraction is:

Y=4.219/(4.219+5.512)=0.43

The anion charge fraction is:

X=5.590/(5.590+(2×2.115))=0.57

When this point is plotted on the Janecke diagram (see FIG. 5) it falls on the sodium bicarbonate precipitation area. Therefore, the first solid to form will be sodium bicarbonate if the water content is less than 78 wt % as indicated by the grid points (not shown in the diagram for clarity). In this example, the water content of the reactants is 50.7 wt %. Therefore, sodium bicarbonate will precipitate. Point (1.0, 1.0) in the right top corner represents the composition of the first solid which we know to be one hundred percent sodium bicarbonate. The composition of the mother liquor will change along the dashed line drawn through points (0.57, 0.43) and (1.0, 1.0) until the mother liquor anion and cation charge fraction point and water concentration meet. The three points must form a straight line through the initial reactants point termed an operating line. This operating line represents a unit operation in the process.

If the ammonium bicarbonate/sodium bicarbonate saturation line is reached before the mother liquor charge fraction point and water concentration meet, then ammonium bicarbonate will begin to co-precipitate. The composition of the mother liquor will then change along the sodium bicarbonate/ammonium bicarbonate saturation line towards the left. The composition of the solid will begin to change along the secondary ‘Y’ axis (1,Y2), moving down from one hundred percent sodium bicarbonate.

The final operating line and end point solid and mother liquor can be found by trial and error utilizing the lever rule. The lever rule is a way of calculating the proportions of each phase on a phase diagram. It is based on conservation of mass and can be proven mathematically. For this example, the lever rule demonstrates that the relative mass amounts of solid and mother liquor are inversely proportional to the distance of the end point of each phase from the initial reactants point.

In this example, the mother liquor and solid end points are at the ends of the solid line drawn through the initial reactants point (see FIG. 5).

The preceding illustrates how to use the Janecke diagram. The following illustrates how the Janecke diagram can be used for process optimization.

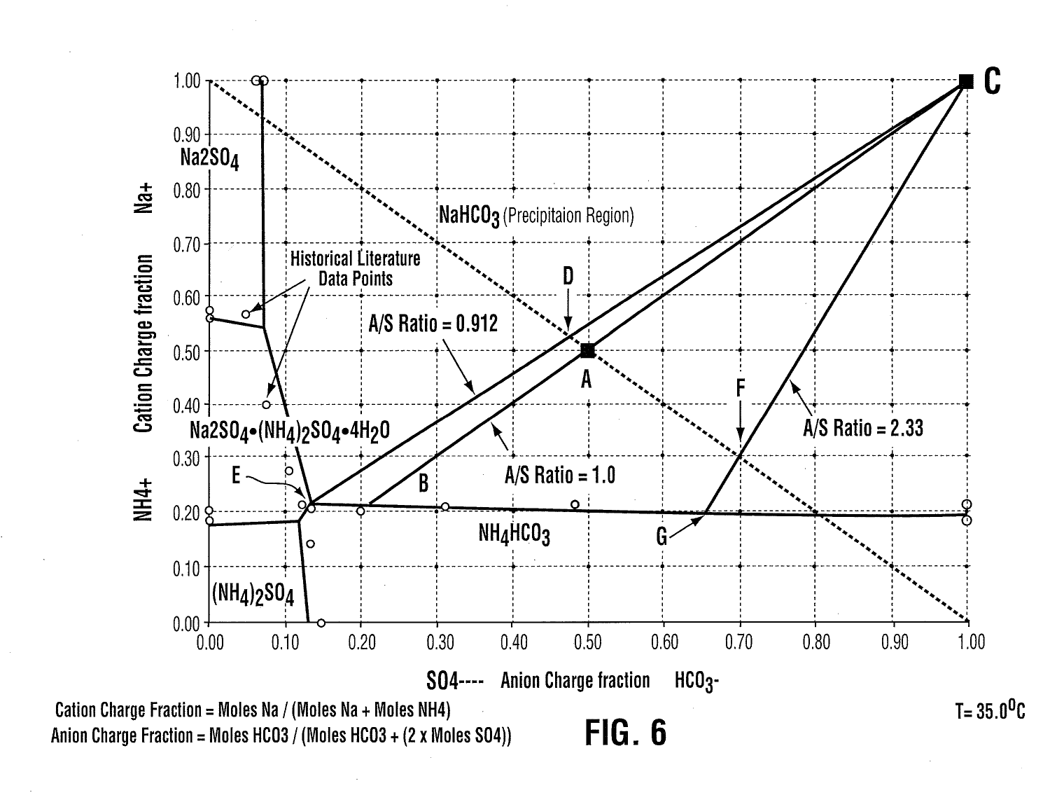

Any mixture of sodium sulfate and sodium bicarbonate will result in an initial starting point (reactants) that falls on the diagonal line drawn between points (0,1) (100% sodium sulfate) and (1,0) (100% ammonium bicarbonate) (see dashed line in FIG. 6).

The goal is to precipitate sodium bicarbonate, so the composition of the feed (reactants) has to be adjusted such that the plot of the reactants anion and cation charge fractions falls on the sodium bicarbonate saturation surface. The following illustrates how to determine the optimal reactants starting point or ammonium to sodium ratio.

If the feed has an equi-molar ratio of ammonium to sodium (A/S ratio=1.0) then the plot of the reactants charge fractions falls on the point (0.5, 0.5) (point A in FIG. 6). If the water content in the feed is adjusted such that precipitation stops just at the sodium bicarbonate/ammonium bicarbonate saturate line, we know that the resultant mother liquor and solids fall at points B and C respectively. The mass of sodium bicarbonate produced can then be determined by using the lever rule.

Looking at the diagram, the observation can be made that a feed with an excess of sodium up to the point where the end point mother liquor stops just short of the sodium bicarbonate/ammonium bicarbonate/double salt (Na₂SO₄—(NH₄)₂SO₄-4H₂O) invariant point (point E) will provide the maximum “once through” yield of sodium bicarbonate. This feed point is shown as ‘D’ on the diagram. With a feed corresponding to point D (and water content adjusted such that precipitation stops when the end point mother liquor just reaches the triple point), the ratio of the distances on the Janecke (lever rule) results in the maximum amount of sodium bicarbonate produced. Any feed with more or less excess sodium will result in less sodium bicarbonate production. The following three examples will illustrate this point. To simplify the analysis, it is assumed in all cases that precipitation will stop when the mother liquor reaches the sodium bicarbonate/ammonium bicarbonate saturation line. Therefore, the solid produced will always be one hundred percent sodium bicarbonate.

### Case 1: Ammonium to Sodium Molar Ratio=1.0

If a feed has 1 mol of Na+ and an ammonium to sodium ratio of 1.0, then the feed composition may be as follows:

### Na⁺=1 mol (23.0 g)

### NH₄⁺=1 mol (18.0 g)

### HCO₃⁻=1 mol (61.0 g)

### SO₄²⁻=0.5 mol (48.0 g).

Using the Janecke and the lever rule, the mass of solid sodium bicarbonate produced is 53.7 g. One can appreciate that this solid is 100% sodium bicarbonate. Therefore, Na⁺ and HCO₃⁻ conversion to sodium bicarbonate is 63.9%.

### Case 2: Maximum Once Through Sodium Bicarbonate Production (A/S Molar Ratio=0.912)

As discussed, point D in FIG. 6 represents the feed that will result in the maximum production of sodium bicarbonate on a once through basis. Point D has Janecke coordinates of (0.477, 0.523). If a feed has 1 mol of Na⁺, then it contains 0.5 mols of SO₄²⁻. The moles of NH₄⁺ and HCO₃⁻ are equal and can be found from:

0.523=Mols Na⁺/(Mols Na⁺+Mols NH4⁺)

or

0.477=Mols of HCO₃⁻/(Mols of HCO₃⁻+(2×Mols SO₄²⁻)

These give 0.912 moles of NH₄⁺ and HCO₃⁻ and an ammonium to sodium molar ratio of 0.912. Therefore, we have a feed with the following composition:

### Na⁺=1 mol (23.0 g)

### NH₄⁺=0.912 mol (16.4 g)

### HCO₃⁻=0.912 mol (55.6 g)

### SO₄²⁻=0.5 mol (48.0 g)

### Total=143.0 g

As before, using the Janecke and the lever rule, the mass of solid sodium bicarbonate produced is 55.6 g, sodium conversion is 66.2% and bicarbonate conversion is 72.6%. Likely, these are the highest conversions of sodium and bicarbonate possible on a once through basis.

### Case 3: Ammonium to Sodium Molar Ratio of 2.33

Point F in FIG. 6 represents a feed with a large excess of ammonium. If a feed has 1 mol of Na⁺ then it contains 0.5 moles of SO₄²⁻. The mols of HCO₃⁻ and NH₄⁺ are equal and can be found from:

0.3=Mols Na⁺/(Mols Na++Mols NH4+)

or

0.7=Mols of HCO3-/(Mols HCO3-+(2×Mols SO42-)

These give 2.33 moles of NH₄⁺, 2.33 moles of HCO₃⁻ and an ammonium to sodium ratio of 2.33. Therefore, we have a feed with the following composition:

### Na⁺=1 mol (23.0 g)

### NH₄⁴=2.33 mol (41.9 g)

### HCO₃⁻=2.33 mol (142.1 g)

### SO₄²⁻=0.5 mol (48 g)

### Total=255.0 g

Again, using the Janecke and the lever rule, the mass of sodium bicarbonate produced is 30.3 g, sodium conversion is 36.1% and bicarbonate is 15.5%.

These examples illustrate that on a once through basis, an ammonium to sodium ratio of 0.912 may result in the maximum once through conversion of reactants to solid sodium bicarbonate. However, these examples do not show the magnitude of the combined salt and double salt recycle streams that result from the different feed ammonium to sodium ratios. It has been found that a slight excess of ammonium is favorable because when there is even a slight excess of sodium, the recycles become extremely large. This is because ammonia is very volatile in comparison to sodium and results in a final ammonium to sodium ratio of 1.0. Sodium is non-volatile and will stay in solution and build up in the system. From an equipment capital cost and energy consumption point of view, these large recycles would deteriorate the economics.

The determination of the fact that a slight excess of ammonium is favorable was done utilizing a process simulator because to try and determine this fact with hand calculations would be impractical due to the time required. A thorough understanding of the chemistry combined with the utilization of a powerful process simulator has enabled the optimum ammonium to sodium ratio to be found. The process simulator Hysis™ coupled with the OLI™ property package was used. It has been found that Hysis™ matches very closely to measured analytical data for all of the chemical equilibrium involved in the present invention. The following table illustrates how well Hysis™ matches published measured data (which the Janecke is based on) for the preceding examples.

TABLE 1
Determination of Optimal Ammonium To Sodium Ratio- Hysis vs
Janecke Diagram

| | | |
|---|---|---|
| Janecke | Hysis | % Difference |

Example 1 (A/S Ratio = 1.0)

| | | | |
|---|---|---|---|
| Solid Produced (g) | 53.7 | 53.1 | 1.1 |
| Sodium Conversion (%) | 63.9 | 63.2 | 1.1 |
| Bicarbonate Conversion (%) | 63.9 | 63.2 | 1.1 |

Example 2 (A/S Ratio = 0.912)

| | | | |
|---|---|---|---|
| Solid Produced (g) | 55.6 | 53.8 | 3.2 |
| Sodium Conversion (%) | 66.2 | 64.0 | 3.2 |
| Bicarbonate Conversion (%) | 72.6 | 70.3 | 3.2 |

Example 2 (A/S Ratio = 2.33)

| | | | |
|---|---|---|---|
| Solid Produced (g) | 30.3 | 27.0 | 11.1 |
| Sodium Conversion (%) | 36.1 | 32.1 | 11.1 |
| Bicarbonate Conversion (%) | 15.5 | 13.8 | 11.1 |

Therefore, because Hysis™ is known to match measured equilibrium data applicable to the present invention, its results are used rather than hand calculations and Janecke diagrams for the remaining examples.

In addition to the use of a process simulator to model and understand the process, proprietary lab testing of the chemistry involved in the present invention was done. This testing provided additional verification of the validity of the results of the simulator and also showed that the chemical processes involved in the present invention are equilibrium based and are not limited kinetically. This fact is important. If the chemistry was kinetically limited, this would deteriorate the economic viability of the process. The following table provides a sample of how well Hysis matches the results of the proprietary lab testing.

TABLE 2
Comparison of Hysis Results to Results of Proprietary Testing

| | Propriety Testing | Hysis | % Error |
|---|---|---|---|
| 27.5 wt % SS Feed (g/hr) | 950 | 950 | n/a |
| ABC Feed (g/hr) | 530 | 530 | n/a |
| Glauber's Salt Fed (g/hr) | 290 | 290 | n/a |
| Cryst. Temp © | 40 | 40 | n/a |
| Centrate Ph | 8.65 | 7.85 | 10.2 |
| Centrate Product (Note 1) (g/hr) | 1430 | 1445 | −1.0 |
| SBC Product (g/hr) | 270 | 275 | −1.8 |

### Example 2

### Illustration of the Impact of Lower Sodium Sulfate Concentration in the Feed on Once Through Conversion to Sodium Bicarbonate in Sodium Bicarbonate Precipitation Step

This example illustrates the negative impact of excessive water in the sodium sulfate feed solution on the once through conversion to sodium bicarbonate in the sodium bicarbonate precipitation step. The calculations were done utilizing the process simulator Hysis™ coupled with OLI's™ property package.

Take as an example, the feed shown in Table 3 below which is derived from sodium bicarbonate scrubbing of flue gas generated by burning coal.

This feed has a water concentration of 78.1 wt % and when it is mixed with 112.2 kg of anhydrous ammonium bicarbonate (ammonium to sodium molar ratio of 1.10) and the temperature is adjusted to 38° C., 47.0 kg of sodium bicarbonate precipitate is produced. The once through conversions of the sodium and bicarbonate to sodium bicarbonate are 19.6% and 39.4% respectively.

TABLE 3
EXAMPLE FEED SOLUTION COMPOSITION
Component Flows

| | | |
|---|---|---|
| Water—H2O | kg | 717.0 |
| Carbon Dioxide—CO2 | kg | 0.0 |
| Ammonia—NH3 | kg | 0.0 |
| Sodium Ion—Na | kg | 65.5 |
| Ammonium Ion—NH4 | kg | 0.0 |
| Carbonate Ion—CO3 | kg | 4.3 |
| Bicarbonate Ion—HCO3 | kg | 3.8 |
| Sulphate Ion—SO4 | kg | 119.0 |
| Nitrate Ion—NO3 | kg | 5.6 |
| Fluoride Ion—F | kg | 0.2 |
| Chloride Ion—Cl | kg | 2.5 |
| Hydrogen Ion—H | kg | 0.0 |
| Hydroxide Ion—OH | kg | 0.0 |
| Total | kg | 917.7 |

Component Wt %

| | |
|---|---|
| Water—H2O | 78.1 |
| Carbon Dioxide—CO2 | 0.0 |
| Ammonia—NH3 | 0.0 |
| Sodium Ion—Na | 7.1 |
| Ammonium Ion—NH4 | 0.0 |
| Carbonate Ion—CO3 | 0.5 |
| Bicarbonate Ion—HCO3 | 0.4 |
| Sulphate Ion—SO4 | 13.0 |
| Nitrate Ion—NO3 | 0.6 |
| Fluoride Ion—F | 0.0 |
| Chloride Ion—Cl | 0.3 |
| Hydrogen Ion—H | 0.0 |
| Hydroxide Ion—OH | 0.0 |
| Total | 100.0 |

Removing 179.7 kg of water from this stream decreases the water concentration to 72.8 wt % and when this concentrated stream is mixed with 112.2 kg of anhydrous ammonium bicarbonate and the temperature is adjusted to 38° C., the “once through” production of sodium bicarbonate increases from 47 kg to 69.3 kg. The “once through” conversions of the sodium and bicarbonate to sodium bicarbonate increase from 19.6% to 29.0% and from 39.4% to 58.1% respectively.

Therefore, reducing the amount of water in the sodium sulfate feed solution significantly increases the conversion of sodium and bicarbonate to sodium bicarbonate. It also significantly improves the overall process efficiency since the size of the recycle streams is inversely proportional to the sodium conversion efficiency.

### Example 3

### Impact of Water Concentration on Salt Produced in Combined Salt Precipitation Step

This example illustrates the negative impact of incorrect water concentration in the combined salt precipitation step.

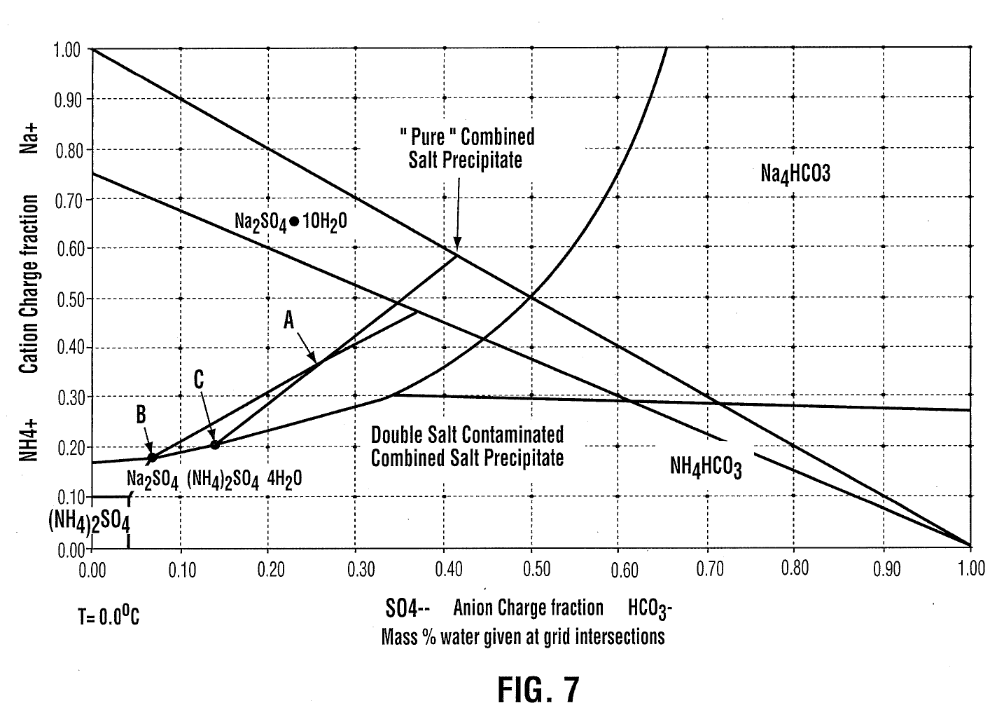

FIG. 7 shows the Janecke diagram that represents the phase equilibrium in the combined salt precipitation step at a temperature of 0° C. If point A represents the charge fraction plot of the feed, it will be obvious to one skilled in the art that it is very important to ensure that the water concentration in the feed is adjusted such that the final mother liquor “stops” before the Glauber's salt/ammonium bicarbonate/double salt invariant point (point B) is reached (i.e. at point C). Otherwise, double salt will form in addition to combined salt on a once through basis. This means that products (ammonium sulfate) begin to recycle back to the sodium bicarbonate precipitation step, reducing the overall efficiency of the process. This contamination will get worse as the process reaches a new equilibrium deteriorating the commercial viability of the process.

The following calculations done utilizing the process simulator Hysis™ with the OLI™ property package emphasize this point. Take as an example, a combined salt precipitation step feed with the composition shown in Table 4 below is exemplified.

TABLE 4
EXAMPLE COMBINED SALT PRECIPITATION STEP FEED
Component Flows

| | | |
|---|---|---|
| Water—H2O | kg | 695.8 |
| Carbon Dioxide—CO2 | kg | 0.3 |
| Ammonia—NH3 | kg | 1.1 |
| Sodium Ion—Na | kg | 38.3 |
| Ammonium Ion—NH4 | kg | 94.6 |
| Carbonate Ion—CO3 | kg | 20.7 |
| Bicarbonate Ion—HCO3 | kg | 117.5 |
| Sulphate Ion—SO4 | kg | 198.0 |
| Nitrate Ion—NO3 | kg | 5.8 |
| Fluoride Ion—F | kg | 0.2 |
| Chloride Ion—Cl | kg | 2.6 |
| Hydrogen Ion—H | kg | 0.0 |
| Hydroxide Ion—OH | kg | 0.0 |
| Total | kg | 1174.7 |

Component Wt %

| | |
|---|---|
| Water—H2O | 59.2 |
| Carbon Dioxide—CO2 | 0.0 |
| Ammonia—NH3 | 0.1 |
| Sodium Ion—Na | 3.3 |
| Ammonium Ion—NH4 | 8.1 |
| Carbonate Ion—CO3 | 1.8 |
| Bicarbonate Ion—HCO3 | 10.0 |
| Sulphate Ion—SO4 | 16.9 |
| Nitrate Ion—NO3 | 0.5 |
| Fluoride Ion—F | 0.0 |
| Chloride Ion—Cl | 0.2 |
| Hydrogen Ion—H | 0.0 |
| Hydroxide Ion—OH | 0.0 |
| Total | 100.0 |

To this feed, 191.3 kg of double salt recycled from the downstream double salt precipitation step is added. If 161.0 kg of water is also added and the mixture chilled to 32 degree F., the resultant salt precipitated will contain 100 kg of ammonium bicarbonate, 217 kg of Glauber's salt and no double salt. If the 161.0 kg of water is not added, the resultant salt precipitated will contain 111.6 kg of ammonium bicarbonate, 198.4 kg of Glauber's salt and 42 kg of double salt. Not only has this increased the mass flow of the combined salt recycle by 10% (on a once through basis), but there is also a product being recycled (ammonium sulfate) back to the sodium bicarbonate precipitation step. If this double salt contamination is allowed to continue (by not properly adjusting the water content), the efficiency of the process deteriorates.

Carbon dioxide from the sodium bicarbonate crystallizer and possibly the bicarbonate removal step or external sources is also added to the combined salt precipitation step to push the anion charge fraction to the right. This helps, in conjunction with proper water adjustment, to keep a double salt from forming.

### Example 4

### Illustration of Chemical Equilibrium Involved in the Production of Pure Ammonium Sulfate from a Mixed Solution of Sodium Sulfate and Ammonium Sulfate

FIG. 8 shows the T-x (temperature-composition) diagram that applies to the chemical equilibrium involved in the production of high quality ammonium sulfate from solutions containing sodium sulfate and ammonium sulfate.

An analysis of FIG. 8 reveals that a very slight change in the cation charge fraction (Y axis) of the solution can shift it from the ammonium sulfate saturation plane to the sodium sulfate or double salt saturation planes. If this happens, it is not possible to produce high quality ammonium sulfate. The prior art was deficient in demonstrating the understanding of this system as shown in FIG. 8. This deficiency made it very difficult to manipulate the process variables to produce a solution with a cation charge fraction that falls in the ammonium sulfate saturation plane.

As another example, the solution with the composition as shown in Table 5 was studied.

TABLE 5
EXAMPLE AMMONIUM SULFATE/SODIUM SULFATE SOLUTION
Component Flows

| | | |
|---|---|---|
| Water—H2O | Kg | 1127.8 |
| Carbon Dioxide—CO2 | Kg | 0.0 |
| Ammonia—NH3 | Kg | 2.3 |
| Sodium Ion—Na | Kg | 37.0 |
| Ammonium Ion—NH4 | Kg | 190.7 |
| Carbonate Ion—CO3 | Kg | 0.0 |
| Bicarbonate Ion—HCO3 | Kg | 0.0 |
| Sulphate Ion—SO4 | Kg | 450.1 |
| Nitrate Ion—NO3 | Kg | 108.8 |
| Fluoride Ion—F | Kg | 2.5 |
| Chloride Ion—Cl | Kg | 32.9 |
| Hydrogen Ion—H | Kg | 0.0 |
| Hydroxide Ion—OH | Kg | 0.0 |
| Total | Kg | 1952.0 |

Component Wt %

| | |
|---|---|
| Water—H2O | 57.8 |
| Carbon Dioxide—CO2 | 0.0 |
| Ammonia—NH3 | 0.1 |
| Sodium Ion—Na | 1.9 |
| Ammonium Ion—NH4 | 9.8 |
| Carbonate Ion—CO3 | 0.0 |
| Bicarbonate Ion—HCO3 | 0.0 |
| Sulphate Ion—SO4 | 23.1 |
| Nitrate Ion—NO3 | 5.6 |
| Fluoride Ion—F | 0.1 |
| Chloride Ion—Cl | 1.7 |
| Hydrogen Ion—H | 0.0 |
| Hydroxide Ion—OH | 0.0 |
| Total | 100.0 |

The cation charge fraction (Y axis in FIG. 7) is calculated as follows: cation charge fraction=1.609/(1.609+10.594)=0.13

Referring to FIG. 7, with a cation charge fraction of 0.13, the solution falls on the ammonium sulfate saturation plane providing the temperature and water content are also adjusted correctly. By adjusting the feed solution such that it falls on the ammonium sulfate saturation plane, it is possible to produce high purity ammonium sulfate with the correct amount of water removal or cooling. If the above solution contained 125 kg of sodium instead of 37 kg, the moles of sodium would be 5.435 kg moles and the cation charge fraction would be 0.34. At this cation charge fraction, it would be impossible to produce pure ammonium sulfate. Assuming that the temperature and water content were such that the solution falls onto the sodium sulfate saturation plane just above the sodium sulfate/ammonium sulfate co-precipitation line, only sodium sulfate would be produced until this line is hit, at which point a mixture of ammonium sulfate and sodium sulfate would be produced (if water were removed from the system). If instead of removing water the solution is cooled, sodium sulfate would precipitate until the sodium sulfate/double salt saturation line is reached at which point sodium sulfate and double salt would co-precipitate. There would be no ammonium sulfate production at all.

The present invention elegantly ensures that the solution from which pure ammonium sulfate is precipitated falls within the ammonium sulfate saturation plane. This is accomplished by the unique configuration of the combined salt precipitation step followed by the double salt precipitation steps which control the amount of sodium in the solution.

Although specific embodiments of the invention have been described above, it is not limited thereto and it will be apparent to those skilled in the art that numerous modifications form part of the present invention insofar as they do not depart from the spirit, nature and scope of the claimed and described invention.

### Flue Gas Processing

Flue gas may be produced as a by-product of combustion of fossil fuels and may substantially contain the following constituents: nitrogen (N2) (65-75%); oxygen (O2) (5-10%); water vapor (H2O) (4-10%); and carbon dioxide (CO2) (15-20%), on a weight per weight basis. Therefore, flue gas conditioning can provide a source of sodium sulfate and sodium nitrate for the manufacture of fertilizer, as described above and a source of carbon dioxide for the manufacture of sodium bicarbonate. However, flue gas may also contain a variety of air pollutant species such as: sulfur dioxide (SO2); sulfur trioxide (SO3); hydrochloric acid (HCl); hydrogen fluoride (HF); nitric oxide (NO); nitrogen dioxide (NO2); dinitrogen pentoxide (N2O5); mercury (Hg); and, other air toxins. An embodiment of the present invention is a process to remove the aforementioned air pollutants from flue gas with the end products of a sodium or potassium based salt that comprises feedstock for the manufacture of fertilizer.

For treatment, generally referred to as process 100, the flue gas is exposed to a series of steps that comprise chemical reactions. For example, the present invention may utilize the thermal energy, or heat, of flue gas in at least three steps to facilitate a series of chemical reactions that remove pollutants from said flue gas. The flue gas may also be exposed to an oxidative stress to render insoluble pollutants more soluble. The process may also provide a means for sequestering and removing CO2 from flue gas.

In one embodiment of treatment 100, flue gas may enter a first fluidic stream 102 and be treated with a dry sorbent, in a first step 104. The dry sorbent may be of a particle size between 10 and 90 microns. For example, in one embodiment the dry sorbent may be alkaline, such as NaHCO3 and it may be of a particle size of less than 20 microns for optimal recovery and reactivity and directly injected into a fluidic stream of the flue gas that is between 200 and 350 degrees F. Further, the NaHCO3 sorbent may be injected in excess of 1.1 to 1.2 times greater than the required stoichiometric ratio to react with SO2, SO3, NO and NO2 as measured in the first fluidic stream.

For the purposes of this disclosure, SO2 and SO3 species may be collectively referred to as SOx. Further, nitrogen containing reactive species, such as NO, NO2, N205 and other nitrogen-containing species recognized by those skilled, may be collectively referred to as NOx.

The flue gas may heat the NaHCO3 to, for example 300 degrees F., causing calcination of the sorbent to form sodium carbonate (Na2CO3) as follows:

NaHCO3+heat [symbol] Na2CO3+CO2+H20

The calcination process may increase the surface area of the sorbent and thereby increase the reactivity. Calcination of the sorbent may also contribute towards oxidizing heavy metals, such as Hg. As will be discussed further below, oxidized Hg is soluble and therefore can be more readily removed from the flue gas, as compared to elemental Hg.

Calcination of NaHCO3 may cause a conversion of substantially all NaHCO3 to Na2CO3. There may be residual amounts of NaHCO3 to react with the flue gas stream. NaHCO3 and Na2CO3 may react with SOx and NOx constituents of the flue gas, for example, as follows:

2NaHCO3+SO2+½O2 [symbol] Na2SO4+H20+2CO2

Na2CO3+SO2+½O2 [symbol] NaSO4+CO2+H20

2NaHCO3+SO3 [symbol] Na2SO2+H2O+2CO2

2NaHCO3+SO2+NO+O2 [symbol] Na2SO4+NO2+H2O+2CO2

2NaHCO3+2NO2+½O2 [symbol] 2NaNO3+H20+2CO2

4Na2SO3+2NO2 [symbol] 4Na2SO4+N2

2NO+2SO2 [symbol] 2SO3+N2

As one skilled in the art can appreciate, the stoichiometric ratio of sorbent to SOx can be manipulated so that there is a very high removal of SO3, in the form of Na2SO4, upwards of 95-99.99% of total SO3 may be removed. Further, experimental data has shown that there may be 40-90% removal of the total SO2 content of the flue gas.

Any unreacted NaHCO3 may be calcined to Na2CO3 by the temperature of the flue gas. Further, the by-products of the dry injection reactions such as: Na2SO3, Na2SO4, NaNO3 are soluble and aerosolized within the stream of hot flue gas. The solubility of these by-products may reduce the requirement for a bag house or wet electrostatic precipitator to control particulate matter.

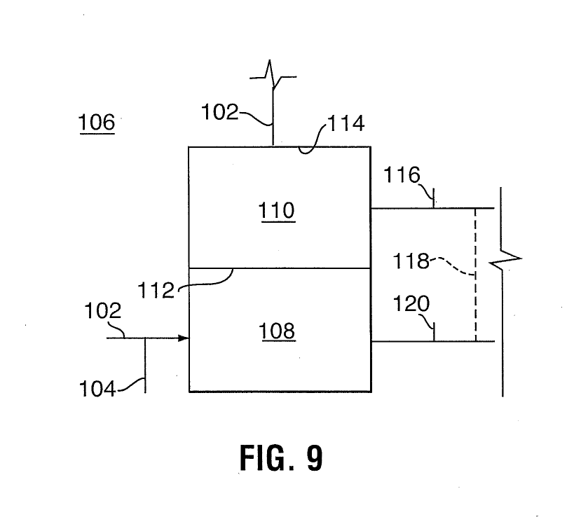

The dry alkaline sorbent injection steps described above may occur within duct work, as a suitable for each location that the present invention is employed. Further, as a means of transporting the flue gas and aerosolized reaction by-products a simple exhaust fan, or suitable substitute, may be used for example to direct the flue gas and aerosolized reaction by-products towards a wet scrubber and oxidation apparatus 106 see example at FIG. 9.

The wet scrubber and oxidation apparatus may have a lower section 108 and an upper section 110. While the flue gas and by-products pass through lower section 108 they may be exposed to an aqueous spray of a Na2CO3 solution 112, by methods and apparatus appreciated by those skilled in the art.

Any excess Na2CO3 from the first step may be recycled into solution and react with any unreacted SOx or soluble NOx species within the flue gas to form the soluble products of formulas depicted above. All soluble byproducts are removed from the flue gas and enter into the feedstock stream 120.

From the lower section flue gas, by-products of the aforementioned chemical reactions and any insoluble pollutants or other constituents of the flue gas may be directed towards upper section 110. Within the upper section the flue gas will react with a stream of oxidants 114, NOx (primarily in the form of NO, NO2, or other dimers) and mercury (elemental and oxidized) are removed. Wet scrubber 108 and oxidation apparatus 110 may use a tray like a bubble cap tray or a separate vessel to keep the oxidant stream, separate from the lower section and the reagents reacting therein. Mass transfer surfaces such as additional trays, sprays or packing are added as required. Following the reactions within the lower and upper flue gas 102 is scrubbed and essentially free of all SOx and has up to 99% or more of the mercury and NOx removed from the flue gas. The oxidant stream 116 may be purged, or if appropriate the oxidant stream may be directed to fortify the feedstock stream with further sodium and nitrogen based compounds (as shown in FIG. 9, dotted line 118).

The following is a non-exhaustive list of suitable oxidants for the capture of NOx and/or Hg or Hg compounds: hydrogen peroxide (H2O2); hydrogen peroxide/nitric acid solution H2O2/HNO); hydrogen peroxide/nitric acid/hydrochloric acid solution (H2O2/HNO3/HCl); sodium chlorate solution (NaClO3); sodium chlorite solution (NaClO2); sodium hypochlorite solution (NaClO); sodium perchlorite solution (NaClO4); chloric acid solution (HClO3); oxone solution (2 KHSO5-KHSO4-K2SO4 Triple Salt); potassium chlorate Solution (KClO); potassium chlorite solution (KClO2); potassium hypochlorite solution (KClO); potassium perchlorite solution (KClO4); potassium permanganate (KMnO4); and potassium permanganate/sodium hydroxide solution (KMnO4/NaOH).

One embodiment of the wet scrubber and oxidant stage could be an integral reaction zone that re-circulates an aqueous solution of oxidant and reaction products to effectively remove all the NOx and much of the Hg, simultaneously from the flue gas.

Following the wet scrubber and oxidant stage, the flue gas may be directed towards a carbonation vessel 200. Within the carbonation vessel there may be a source of substantially pure Na2CO3 which will react with the CO2 within the flue gas and, in conjunction with the temperature of the flue gas, for example from 100 Deg F. to 175 degrees F. within the carbonation vessel, drive a carbonation reaction as follows:

Na2CO3+CO2+H2O→2NaHCO3

This reaction may cause the absorption of CO2 from the flue gas and may remove a broad range of 40 to 92%, or for example a more narrow range of 85-90%, of total CO2 may be removed from the flue gas. Due to the prior reaction steps the substantially pure Na2CO3 utilized within the carbonation step may remain substantially free of contaminants. This purity, in conjunction with the relatively cooler temperature, may assist in driving the carbonation reaction described above and permit the repetition of numerous subsequent carbonation cycles without substantially contaminating the Na2CO3. Following the carbonation reaction, the flue gas, that is substantially free of pollutants, may be expelled 300 into the atmosphere by methods appreciated by those skilled in the art, such as a flue stack or chimney.

A substantial majority, for example 90%, of the NaHCO3 produced in the carbonation vessel may be diverted to a decarbonation vessel 202 which can provide heat, for example heat that may be transferred from the production of the flue gas or from newly produced flue gas itself, to heat the NaHCO3 to 200 to 350 degree F. As described above, this temperature range will calcine the NaHCO3 to produce substantially pure Na2CO3 to be employed in the carbonation vessel. Further, a portion of the substantially pure Na2CO3 204 may be directed towards pretreatment step 160 for pH adjustments to facilitate the removal of heavy metals, as described above. The remaining NaHCO3, for example 10% may be diverted for use as a dry, alkaline sorbent in the dry injection stage described above.

Sodium bicarbonate 206 may be further sourced from precipitator 16 so that the decarbonation vessel can provide a continuous supply of substantially pure sodium carbonate. These various means of recycling the sodium based salts may provide a means of carbon dioxide removal that does not require costly inputs, such as catalysts.

The H2O may be condensed from gaseous state in a desiccant bed and recycled for various purposes as desired. CO2 that is released from the carbonated sodium carbonate may be directed, as described above, to the reactive crystallization step in the manufacture of fertilizer, sequestration or other uses.

In another embodiment of the present invention, potassium based alkaline salts, such as KHCO3 and K2CO3 may be used in place of the sodium based salts described above. For example, KHO3 may be used as a dry sorbent and wet scrubber for the removal of SOx and NOx species from the flue gas. As such, a potassium based feedstock may be used for the manufacture of fertilizer. Further, KHCO3 and K2CO3 may be used in the carbonation and recarbonation stages for the removal of CO2 from the flue gas.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A method for the isolation of fertilizer precursors from a flue gas stream containing SOx and NOx compounds, said process comprising the steps of:
(a) providing the flue gas stream;
(b) processing the flue gas to form a feedstock, said processing comprising:
(i) a dry injection scrubbing operation;
(ii) a wet scrubbing operation; and
(iii) a carbon dioxide capture operation;
(c) converting the feedstock, through a conversion step to form a sodium bicarbonate precipitate, said conversion step comprising;
(i) adding combined salt containing ammonium bicarbonate and Glauber's salt to the feedstock;
(ii) adding to the feedstock at least one of
(A) carbon dioxide;
(B) ammonia; and
(C) ammonium bicarbonate;
(iii) maintaining an ammonium to sodium ratio of not less than 1;
(iv) removing said sodium bicarbonate precipitate out of solution from step (iii);
(d) mixing said solution from step (c)(iv) with a double salt ;
(e) cooling said mixture from step (d) to form a combined salt;
(f) precipitating the combined salt and removing the combined salt out of solution from step (e);
(g) removing residual bicarbonate from the solution from step (f);
(h) mixing said solution from step (f) with a mother liquor prepared from steps (a) to (g) and further cooled to precipitate out and remove there from a double salt and from which an ammonium salt has been concentrated and removed;
(i) cooling the mixture from step (h) to precipitate double salt;
(j) separating precipitated double salt the solution from step (i) and recycling to step C; and
(k) recovering ammonium salts by concentrating the solution of step (j).

2. The method of claim 1, wherein the ammonium salts are ammonium sulfate, ammonium nitrate or a combination thereof.

3. The method of claim 1, wherein the dry injection scrubbing operation is an injection of dry sorbent into the flue gas to remove substantially all SOx compounds and a substantially large amount of NOx compounds present in the flue gas.

4. The method of claim 1, wherein the wet scrubbing operation includes the steps of:
(a) passing the flue gas through a solution of sodium carbonate to remove any residual SOx and NOx compounds from the flue gas and create soluble sodium sulfate and sodium nitrate salts; and
(b) oxidization of the flue gas by exposure to oxidants.

5. The method of claim 3, wherein the dry sorbent is a sodium based sorbent selected from sodium bicarbonate, sodium carbonate or combinations thereof.

6. The method of claim 3, wherein the dry sorbent is a potassium based sorbent selected from potassium bicarbonate, potassium carbonate or combinations thereof.

7. The method of claim 3, wherein the dry sorbent is a combination of sodium and potassium based sorbent.

8. The method of claim 6, wherein the oxidation of the flue gas occurs by exposure to an oxidant.

9. The method of claim 8, wherein the oxidant is a sodium hypochlorite solution.

10. The method of claim 9, wherein the sodium hypochlorite solution is acidified with nitric acid.

11. The method of claim 10, wherein the sodium hypochlorite solution has a pH of about 5.73.

12. The method of claim 10, wherein said sodium hypochlorite solution has a pH of about 5.73.

13. The method of claim 4, wherein said oxidant includes a sodium hypochlorite solution acidified with hydrochloric acid.

14. The method of claim 13, wherein said sodium hypochlorite solution acidified with hydrochloric acid has a molar concentration of 0.1M NaClO and a pH of about 3.74.

15. The method of claim 13, wherein said sodium hypochlorite solution acidified with hydrochloric acid has a pH of about 5.

16. The method of claim 4, wherein said oxidant includes a sodium hypochlorite solution acidified to have a pH of approximately 6.

17. The method of claim 4, wherein said oxidant is a potassium permanganate and sodium hydroxide solution.

18. The method of claim 4, wherein said oxidant includes a solution of approximately 0.25 mol/l potassium permanganate and approximately 2.5 mol/l sodium hydroxide.

19. The method of claim 4, wherein the oxidation of the flue gas removes residual NOx and at least a portion of Hg or Hg compounds.

20. The method of claim 1, the carbon dioxide capture operation further comprising the exposure of flue gas to a substantially pure sodium carbonate to capture carbon dioxide.

21. The method of claim 20, wherein the substantially pure sodium carbonate is converted to sodium bicarbonate.

22. The method of claim 21, further comprising substantially 90% of the sodium bicarbonate produced is processed through a decarbonation reaction to free water and carbon dioxide and substantially pure sodium carbonate.

23. The method of claim 20, further comprising substantially 10% of the sodium bicarbonate is used in step 1(b)(i).

24. The method of claim 22, further comprising sodium bicarbonate further sourced from step 1(c)(iv).

25. The method of claim 22, wherein the carbon dioxide supplies step 1(c)(ii)(A).

26. The method of claim 4, further comprising a pH adjustment of the feedstock, by the addition of sodium carbonate, to coagulate residual pollutants.

27. The method of claim 4, further comprising a filtration step whereby the feedstock is filtered to remove particles.

28. The method of claim 26, further comprising a filtration step whereby the feedstock is filtered to remove particles following the pH adjustment of the feedstock.

29. A method for removing carbon dioxide from a feed stock, comprising:
(a) processing a flue gas stream to remove substantially all SOx and NOx contaminants;
(b) cooling the flue gas stream to a temperature in the range of 100 to 175 degrees F.;
(c) exposing the flue gas stream to a substantially pure sodium carbonate to remove carbon dioxide from said flue gas stream to create carbonated sodium carbonate;
(d) heating said created carbonated sodium carbonate to a temperature in the range of 200 to 350 degrees F. to release carbon dioxide and water and produce substantially pure sodium carbonate; and
(e) recycling said substantially pure sodium carbonate back to step (a) to remove carbon dioxide from the flue gas stream.

30. The method of claim 29, wherein about 40 to 92% of the total carbon dioxide is removed from the feedstock.

31. The method of claim 29, wherein about 85 to 90% of the total carbon dioxide is removed from the feedstock.

32. The method of claim 29, wherein the released carbon dioxide is directed to a process for the manufacture of granular fertilizer.
